(19) United States
(12) Patent Application Publication
(10) Pub. No.: US 2021/0037860 A1
(43) Pub. Date: Feb. 11, 2021

(54) METHODS OF DEGRADING AFLATOXIN B1 IN PEANUT POWDER USING OZONE

(71) Applicant: Mars, Incorporated, McLean, VA (US)

(72) Inventors: Guangtao ZHANG, Beijing (CN); Ying LI, Beijing (CN); Yuwei CHANG, Beijing (CN); Robert BAKER, Beijing (CN)

(73) Assignee: Mars, Incorporated, McLean, VA (US)

(21) Appl. No.: 16/966,420

(22) PCT Filed: Jan. 31, 2018
(86) PCT No.: PCT/CN2018/074697

§ 371 Date: Jul. 30, 2020

(51) Int. Cl. A23L 5/20; A23L 25/00; A23P 10/40

(52) U.S. Cl. CPC A23L 5/276; A23V 2002/00; A23P 10/40; A23L 25/30

(57) ABSTRACT

Peanut powder and methods for treating peanut powder to reduce the concentration of aflatoxin B1 in peanuts are provided. Methods include grinding peanuts to produce peanut powder and exposing the peanut powder to an ozone-rich environment. Ozone-treated peanut powder comprises less than 20 ppb aflatoxin B1 and between 2.0 and 3.0 meq/kg peroxide.

### CROSS-REFERENCE TO RELATED APPLICATIONS

This application is a U.S. national stage patent application of International Patent Application No. PCT/CN2018/074697, filed on Jan. 31, 2018, the entire contents of which are incorporated herein by reference.

### FIELD OF THE DISCLOSURE

This invention relates to the methods of degrading aflatoxin B1 in food products using ozone and food products with reduced amounts of aflatoxin B1. More particularly, this invention relates to peanut powders with reduced aflatoxin B1 and methods of degrading aflatoxin B1 in peanut powder using ozone.

### BACKGROUND OF THE DISCLOSURE

Mycotoxins are secondary metabolites produced by certain types of fungi often found in crops such as grains, peanuts, tree nuts, and corn. Most mycotoxins are very toxic and dangerous to humans and animals. Further, some mycotoxins are known carcinogens.

A specific type of mycotoxin, aflatoxin B1, is a highly potent contaminant produced by the fungi Aspergillus flavus and A. parasiticus during the storage of many staple crops. Even with the best agricultural practices, contamination is unavoidable. However, high levels of aflatoxin B1 has been shown to have carcinogenic, mutagenic, teratogenic, and immunosuppressive effects. Not only are food products contaminated with high levels of aflatoxin B1 unsafe for human consumption, but they are also unsafe for animal consumption as well. Even animal products (meat, milk, eggs, etc.) from animals who have consumed aflatoxin B1-contaminated food products are unsafe for human consumption.

Peanuts are used as an ingredient in many food products such as candy bars, peanut butter, granola and cereal bars, and cookies. However, peanuts with high levels of aflatoxin B1-contamination and other defective peanuts are generally physically sorted from the uncontaminated peanuts and destroyed. This is because once aflatoxin B1 has developed in food products, it is difficult to remove. Known methods and systems for physically removing aflatoxin B1 from peanuts include color sorting, density separation, and physical binding. However, physical methods and systems only segregate contaminated peanuts from uncontaminated peanuts; these methods do not solve the problem of aflatoxin B1 content in the defective peanuts.

Methods of using biotransforming agents to degrade aflatoxin by microorganisms and the incorporation of microbial enzymes has been used to reduce aflatoxin B1 levels, but these methods have not proven to be commercially effective.

### SUMMARY OF THE DISCLOSURE

As discussed above, the most common methods for degrading aflatoxin B1 in peanuts include physical sorting, physically segregation, and the use of biotransforming agents. However, these methods are incapable of degrading aflatoxin B1 in naturally-contaminated peanuts consistently and effectively.

Accordingly, described are methods and systems for lowering aflatoxin B1 in naturally-contaminated peanuts to acceptable levels. Also described are peanut products and powders with reduced aflatoxin B1 levels that could be used to produce a variety of products including peanut oil, peanut cakes, and/or peanut powder for animal consumption. Also described are methods and systems for degrading aflatoxin B1 in naturally-contaminated peanuts to minimize waste peanuts that would otherwise be destroyed. The described peanuts may be used to produce a variety of peanut-containing products. In some embodiments, the treated peanuts may be used to produce animal feed.

In some embodiments, the described systems and methods include degrading aflatoxin B1 in peanut powder by exposing the peanut powder to an ozone-rich environment. Ozone may be generated and used to treat peanut powder in gaseous form or in an aqueous form. The peanut powder may be treated with the gaseous or aqueous ozone, and the gaseous or aqueous ozone may oxidize some or all of the aflatoxin B1 present in the peanut powder.

Using ozone to degrade aflatoxin B1 in peanut powders may have several benefits. For example, ozone may be produced on-site, eliminating the cost and risk associated with transporting and storing a potentially dangerous compound. Ozone is highly reactive and self-decomposes into oxygen, eliminating the need to store and dispose of harmful chemicals. Further, ozone is non-residual, meaning that when used to treat food products, it does not leave behind residue like many pesticides and other chemicals currently in use to treat food products. Accordingly, the described methods, systems and products harness these benefits of ozone for degrading aflatoxin B1 in naturally-contaminated peanuts.

In some embodiments a method of reducing aflatoxin B1 content in peanuts is provided, the method comprising: grinding peanuts containing a first amount of aflatoxin B1 to produce a peanut powder; and exposing the peanut powder to an ozone-rich environment to produce a peanut powder with a second amount of aflatoxin B1, wherein the second amount is less than the first amount.

In some embodiments, of the method of reducing aflatoxin B1 content in peanuts, exposing the peanut powder to an ozone-rich environment comprises flowing an ozone-rich gas through the peanut powder at an ozone concentration of 10-30 g/m³.

In some embodiments of the method of reducing aflatoxin B1 content in peanuts, the peanut powder is exposed to the ozone-rich environment for 15 minutes or more.

In some embodiments of the method of reducing aflatoxin B1 content in peanuts, the peanut powder is exposed to the ozone-rich environment for 5 hours or less.

In some embodiments of the method of reducing aflatoxin B1 content in peanuts, the peanut powder is exposed to the ozone-rich environment for 3 hours or less.

In some embodiments of the method of reducing aflatoxin B1 content in peanuts, the peanut powder is exposed to the ozone-rich environment at ambient temperature and pressure.

In some embodiments of the method of reducing aflatoxin B1 content in peanuts, the method further comprises holding the peanut powder in a sealed reaction vessel.

In some embodiments of the method of reducing aflatoxin B1 content in peanuts, the peanut powder is held in the sealed reaction vessel for 15 minutes or more.

In some embodiments of the method of reducing aflatoxin B1 content in peanuts, the peanut powder is held in the sealed reaction vessel for 12 hours or less.

In some embodiments of the method of reducing aflatoxin B1 content in peanuts, the peanuts are ground to an average particle size of less than 20 mesh.

In some embodiments of the method of reducing aflatoxin B1 content in peanuts, the method further comprises presorting peanuts with an elevated amount aflatoxin B1 from peanuts with a lower amount of aflatoxin B1 and grinding and exposing to the ozone-rich environment only peanuts with the elevated amount of aflatoxin B1.

In some embodiments of the method of reducing aflatoxin B1 content in peanuts, the first percentage of aflatoxin B1 is greater than 200 ppb.

In some embodiments of the method of reducing aflatoxin B1 content in peanuts, the second percentage of aflatoxin B1 is less than 20 ppb.

In some embodiments of the method of reducing aflatoxin B1 content in peanuts, the ozone-rich environment is an aqueous ozone environment.

In some embodiments of the method of reducing aflatoxin B1 content in peanuts, the ozone-rich environment is ozone gas in air.

In some embodiments, an ozone-treated peanut powder is provided, the peanut powder comprising: less than 20 ppb aflatoxin B1; and between 2.0 and 3.0 meq/kg peroxide.

In some embodiments of the ozone-treated peanut powder, the peanut powder has an average particle size of less than 20 mesh.

In some embodiments of the ozone-treated peanut powder, the peanut powder has less than 15 ppb aflatoxin B1.

In some embodiments of the peanut powder, the peanut powder has greater than 2.5 meq/kg peroxide.

In some embodiments, a treated peanut powder treated with an ozonolysis process is provided, the treated peanut powder comprising grinding peanuts to produce a peanut powder, and exposing the peanut powder to an ozone-rich environment, the treated peanut powder comprising: less than 20 ppb aflatoxin B1; and between 2.0 and 3.0 meq/kg peroxide.

In some embodiments of the treated peanut powder, exposing the peanut powder to an ozone-rich environment comprises flowing an ozone-rich gas through the peanut powder at an ozone concentration of 10-30 g/m³.

In some embodiments of the treated peanut powder, the treated peanut powder is exposed to the ozone-rich environment for 15 minutes or more.

In some embodiments of the treated peanut powder, the treated peanut powder is exposed to the ozone-rich environment for 5 hours or less.

In some embodiments of the treated peanut powder, the treated peanut powder is exposed to the ozone-rich environment for 3 hours or less.

In some embodiments of the treated peanut powder, the treated peanut powder is exposed to the ozone-rich environment at ambient temperature and pressure.

In some embodiments of the treated peanut powder, the ozonolysis process further comprises holding the peanut powder in a sealed reaction vessel.

In some embodiments of the treated peanut powder, the peanut powder is held in the sealed reaction vessel for 15 minutes or more.

In some embodiments of the treated peanut powder, the peanut powder is held in the sealed reaction vessel for 12 hours or less.

In some embodiments of the treated peanut powder, the treated peanut powder has an average particle size of less than 20 mesh.

In some embodiments of the treated peanut powder, the ozone-rich environment is an aqueous ozone environment.

In some embodiments of the treated peanut powder, the ozone-rich environment is ozone gas in air.

Additional advantages of this invention will become readily apparent to those skilled in the art from the following detailed description. As will be realized, this invention is capable of other and different embodiments, and its details are capable of modifications in various obvious respects, all without departing from this invention. Accordingly, the examples and description are to be regarded as illustrative in nature and not as restrictive.

### BRIEF DESCRIPTION OF THE FIGURES

Exemplary embodiments of the invention will now be described with reference to the accompanying figures, in which:

FIG. 1 is a process diagram of an ozonolysis treatment process according to some embodiments.

FIG. 2 is a diagram of an ozonolysis treatment process according to some embodiments.

FIG. 3 is a graph of resulting aflatoxin B1 concentrations of a plurality of peanut samples subjected to various ozone concentrations and treatment durations according to some embodiments.

FIG. 4 is a graph of ratios of aflatoxin B1 concentration in an untreated peanut sample to the aflatoxin B1 concentration in a treated peanut sample under various treatment conditions according to some embodiments.

FIG. 5 is a table comprising characteristics of peanut samples before and after ozone treatment.

### DETAILED DESCRIPTION OF THE DISCLOSURE

Described are systems and methods for treating peanut powders to degrade aflatoxin B1 in naturally-contaminated peanut powders using ozone. Also described are peanut powders and peanut-containing products with reduced aflatoxin B1 levels.

The inventors have discovered a process whereby contaminated peanuts may be treated with ozone to reduce the aflatoxin B1 content. In some embodiments, methods may include grinding the peanut kernels into a peanut powder, which may be treated with ozone in a reaction vessel at various concentrations of ozone and at various exposure durations. The ground peanuts may include the red skin or the red skin may be removed prior to the grinding process. Treating peanut powder with ozone according to some of the embodiments described herein degrades the aflatoxin B1 content of the peanut powder. In some embodiments, ozone-treated peanuts and peanut powder may be used for human consumption or animal consumption. The described process can be used to reduce the aflatoxin B1 levels in the treated peanut powders to levels that are safe for consumption. The resulting ozone-treated peanut products may then be used, for example, as animal feed instead of going to waste.

Ozone is a known oxidizing agent and may be used to oxidize naturally-occurring aflatoxins in whole peanut kernels. The mechanism of aflatoxin degradation is believed to be based on the C8-C9 double bond of the furan ring and the lactone ring of the aflatoxin compounds, using the Criegee reaction and methoxyl reaction. The chemical compounds of aflatoxin B1, B2, G1, and G2 are shown below:

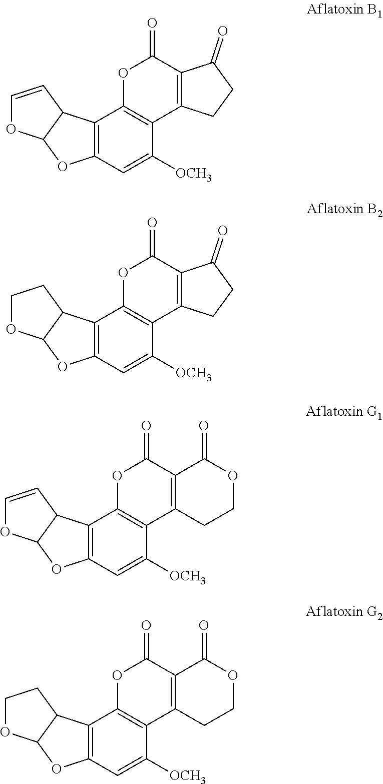 [SMILES: COc1cc2c(c3oc(=O)c4c(c13)CCC4=O)C1C=COC1O2 ; COc1cc2c(c3oc(=O)c4c(c13)CCC4=O)C1CCOC1O2 ; COc1cc2c(c3oc(=O)c4c(c13)CCOC4=O)C1C=COC1O2 ; COc1cc2c(c3oc(=O)c4c(c13)CCOC4=O)C1CCOC1O2]

Aflatoxin B1 and G1 have been shown to degrade faster than aflatoxin B2 and G2, which is presumably due to the additional reaction site, the C8-C9 double bond of the furan ring that is present in aflatoxin B1 and G1, but not aflatoxin B2 and G2.

A challenging aspect of oxidizing food products with ozone is balancing effective rates of toxin degradation while maintaining the quality of the food product. With peanuts, such quality indicators may be related to the skin color, protein, fat, unsaturated fatty acids, electrical conductivity, and crude oil of the peanuts. Quantitatively, free fatty acids, peroxide value, and iodine index may all be measured and analyzed to determine peanut quality after ozonolysis.

In some embodiments, naturally-contaminated whole peanut kernels may be treated with ozone. In some embodiments, naturally-contaminated whole peanut kernels may be ground to a peanut powder for ozone treatment. In some embodiments, whole peanut kernels may be deshelled and ground with the red skin intact. Whole peanut kernels may also be deshelled and ground with the red skin removed. To ground whole peanut kernels, any blender or similar grinder or mill commercially available may be used. In some embodiments, a Weiheng WH-A150 may be used to grind whole peanuts. In some embodiments, a Weiheng WH-A150 may be used at 25000 rpm for 6-10 seconds to achieve a peanut powder suitable for ozone treatment. However, as mentioned above, any commercially available blender, grinder, or mill may be used and optimized to produce peanut powder suitable for ozone treatment.

Gaseous ozone may be formed using an ozone generating device. In some embodiments, gaseous ozone is used to degrade naturally-occurring aflatoxin B1 in peanut powder. An ozone generating device of some embodiments may comprise an ozone generator component, an ozone concentration control, and/or a gas exhaust. In some embodiments, an ozone generating device may comprise two or more outputs, wherein at least one output is for the generated ozone and at least one output is for atmospheric air from an air compressor coupled to the ozone generating device. In some embodiments, residual ozone may be reduced by heating to form oxygen.

Gaseous ozone may be generated using a specific ozone generating device such as a corona discharger apparatus at relatively high concentrations and low cost. Corona discharger apparatuses generate ozone by utilizing an electric discharge process that subjects two electrodes to a high potential difference (for example, a potential difference of 1000V). Oxygen or air is passed between the two electrodes, and the high potential difference between the electrodes causes the two atoms of oxygen (O₂) to dissociate and react with other oxygen molecules to generate ozone (O₃).

Gaseous ozone may also be generated using ionizing radiation. For example, UV radiation may cause the disassociation of oxygen molecules into free radical oxygen atoms, which may then react to form ozone.

Ozone generators are readily available for commercial applications. Examples of ozone generating devices include products by Anseros Advanced Ozone Technologies such as COM-AD-01, COM-AD-01-IP, COM-AD-02, COM-AD-04, COM-AD-08, COM-AD-1000, COM-SD-500, COM-SD-30, MEGAGEN COM-VD-6000, and CD-COM-HF-4. Other similar devices include those by Ozomax Inc. such as OZO-POE Cart, OZO-POE Skid, or OZO-INSITU Skid.

Aqueous ozone may be produced by bubbling gaseous ozone in water. Gaseous ozone may be formed from an ozone generating device and bubbled in a vessel containing water to create an ozone-saturated water solution. When bubbled in water, ozone may partially dissolve to create hydroxyl radicals that may oxidize contaminants in addition to molecular ozone. In some embodiments, whole peanut kernels may be submerged in the aqueous ozone solution for treatment. In some embodiments, peanut powder may be submerged into an aqueous ozone solution for treatment.

In some embodiments, methods for degrading aflatoxin B1 content in naturally-contaminated peanut powders may reduce the average aflatoxin B1 content more than 40%, preferably more than 50%, more preferably more than 60% from their pre-treatment levels. In some embodiments, the methods may reduce the level of average aflatoxin B1 in naturally-contaminated peanut powders more than 70%, or even as much as 80% from their pretreatment levels. In some embodiments, the treated peanut powders may have an average aflatoxin B1 concentration of less than 100 ppb, less than 80 ppb, less than 60, or less than 20 ppb.

Aflatoxin B1 levels plateau and a longer exposure time (for example, exposure time of greater than 3 hours) may not continue to lower aflatoxin levels. In some embodiments, ozonolysis of peanut powder may decrease aflatoxin B1 levels while simultaneously increasing aflatoxin B2, G1 and/or G2 levels. For example, at low ozone concentrations, aflatoxin B2 and G2 may increase up to two-fold in whole peanut kernels exposed to 10 mg/L ozone for 30 minutes. In some embodiments, the content of aflatoxin B2, G1, and/or G2 combined comprise less than one-percent of the total aflatoxin content. Further, the overall toxicity of aflatoxin B2, G1, and G2 is not nearly as potent as that of aflatoxin B1.

Aflatoxin B1 content may be identified using various scientific tools. Some embodiments identify and determine aflatoxin B1 content in samples using chromatographic methods such as high performance liquid chromatography, thin-layer chromatography, and/or gas chromatography. Some embodiments may use spectroscopic methods to identify and determine aflatoxin B1 content in samples such as infrared spectroscopy. Additionally, some embodiments may use immunochemical methods such as radioimmunoassay, enzyme-linked immunosorbent assay, immunoaffinity column assay, and/or immunosensors. Some embodiments may identify and determine aflatoxin B1 content using a fluorotoxinmeter.

Factors that have been shown to affect the efficacy of aflatoxin B1 degradation in peanuts include initial aflatoxin concentration, moisture content, treatment time, treatment temperature, and/or ozone concentration. Naturally-contaminated peanuts can show great variation in aflatoxin content. For example, the aflatoxin B1 level in naturally contaminated whole peanut kernels may be between 40 ppb and 1000 ppb. In some embodiments, whole peanut kernels may be ground to a peanut powder for ozone treatment. By grinding whole peanut kernels to a peanut powder, the aflatoxin B1 level may become homogenous throughout the peanut sample.

The moisture content of the peanuts may vary. In some embodiments, the moisture content of whole peanut kernels may be between 4 and 14%. In some embodiments, the moisture content of peanuts may be between 7 and 11%. In some embodiments, the moisture of the pre-treated peanuts and/or peanut powder may be less than 12%, less than 10%, less than 8%, less than 6%, or less than 5%. In some embodiments, the moisture of the pre-treated peanuts and/or peanut powder may be greater than 5%, greater than 6%, greater than 8%, greater than 10%, greater than 12%, or greater than 14%.

Treatment time, or the amount of time the peanuts or peanut powder is exposed to an ozone-rich environment, may vary. Treatment time may be between 15 minutes and 4 hours. Some embodiments may expose peanuts and/or peanut powders to an ozone-rich environment for between 30 minutes and 3.5 hours. In some embodiments, peanuts and/or peanut powders may be exposed to an ozone-rich environment for between 1 hour and 3 hours. In some embodiments, peanuts and/or peanut powders may be exposed to an ozone-rich environment for between 1.5 hours and 2.5 hours. In some embodiments, the peanuts and/or peanut powders may be exposed to an ozone-rich environment for less than 4 hours, less than 3.5 hours, less than 3 hours, less than 2.5 hours, less than 2 hours, less than 1.5 hours, less than 1 hour, less than 45 minutes, less than 30 minutes, or less than 20 minutes. In some embodiments, the peanuts and/or peanut powders may be exposed to an ozone-rich environment for greater than 15 minutes, greater than 30 minutes, greater than 45 minutes, greater than 1 hour, greater than 1.5 hours, greater than 2 hours, greater than 2.5 hours, or greater than 3 hours.

In some embodiments, the aflatoxin B1 levels may plateau after a certain amount of ozone exposure. For example, aflatoxin B1 levels may plateau and render any treatment time of greater than 15 minutes unnecessary. In some embodiments, aflatoxin B1 levels may plateau and render any treatment time of greater than 10 minutes unnecessary. In some embodiments, aflatoxin B1 levels may plateau and render any treatment time of greater than 30 seconds, greater than 45 seconds, greater than 1 minute, greater than 3 minutes, greater than 5 minutes, or greater than 8 minutes unnecessary.

Further, the treatment temperature of the ozonolysis process may vary. In some embodiments the treatment temperature of the ozonolysis process may be between 20 and 30 degrees Celsius. In some embodiments, the treatment time of the ozonolysis process may be between 22 and 28 degrees Celsius. In some embodiments, the treatment temperature of ozonolysis may be room temperature, or approximately between 23 and 25 degrees Celsius. In some embodiments, the treatment temperature of ozonolysis may be greater than 20 degrees Celsius, greater than 22 degrees Celsius, greater than 24 degrees Celsius, or greater than 26 degrees Celsius. In some embodiments, the treatment temperature of ozonolysis may be less than 30 degrees Celsius, less than 28 degrees Celsius, less than 26 degrees Celsius, or less than 24 degrees Celsius.

Ozone concentration may be between 5 g/m³ and 50 g/m³. In some embodiments, 5-15 g/m³ ozone may be used to treat peanuts. In some embodiments, 15-25 g/m³ ozone may be used to treat peanuts. In some embodiments, 25-35 g/m³ ozone may be used to treat peanuts. In some embodiments, 35-45 g/m³ ozone may be used to treat peanuts. In some embodiments, greater than 5 g/m³ ozone, greater than 10 g/m³ ozone, greater than 12 g/m³ ozone, greater than 15 g/m³ ozone, greater than 18 g/m³ ozone, greater than 20 g/m³ ozone, greater than 23 g/m³ ozone, greater than 25 g/m³ ozone, greater than 28 g/m³ ozone, greater than 30 g/m³ ozone, or greater than 35 g/m³ ozone may be used to treat peanuts. In some embodiments, less than 50 g/m³ ozone, less than 40 g/m³ ozone, less than 35 g/m³ ozone, less than 30 g/m³ ozone, less than 28 g/m³ ozone, less than 25 g/m³ ozone, less than 23 g/m³ ozone, less than 20 g/m³ ozone, less than 18 g/m³ ozone, less than 15 g/m³ ozone, less than 12 g/m³ ozone, less than 10 g/m³ ozone, or less than 8 g/m³ ozone may be used to treat peanuts and/or peanut powders.

In some embodiments, treating peanuts and/or peanut powders may include two discrete phases. In some embodiments, a first phase may include an ozone-rich environment as described above, wherein generated ozone flows through the reaction vessel at a controlled concentration and flow rate for a predetermined amount of time. In some embodiments, a second phase may include a holding period wherein the reaction vessel is sealed. This holding period of the second phase may contain any remaining ozone within the reaction vessel after completion of the first phase, or the ozone-rich environment. In some embodiments, at least some of the remaining ozone within the reaction vessel may self-decompose by converting into oxygen throughout the holding period. In some embodiments, a holding period may be used to convert any remaining ozone to oxygen.

The holding period may last between 15 minutes and 48 hours. In some embodiments, the holding period may be greater than 15 minutes, greater than 30 minutes, greater than 1 hour, greater than 2 hours, greater than 3 hours, greater than 4 hours, greater than 5 hours, greater than 6 hours, greater than 8 hours, greater than 10 hours, greater than 12 hours, greater than 18 hours, greater than 24 hours, or greater than 36 hours. In some embodiments, the holding period may be less than 48 hours, less than 36 hours, less than 24 hours, less than 18 hours, less than 12 hours, less than 10 hours, less than 8 hours, less than 6 hours, less than 5 hours, less than 4 hours, less than 3 hours, less than 2 hours, less than 1 hour, or less than 30 minutes.

After ozonolysis of the peanut powders is complete, the products of the degraded aflatoxin B1 may be analyzed to further characterize the final peanut product. For example, the treated peanuts may be characterized by an increased peroxide value. In some embodiments, a peroxide value may be measured in ozone-treated peanuts to determine autoxidation, or oxidative rancidity, as a result of the ozonolysis. In some embodiments, the peroxide value of ozone-treated peanuts and/or peanut powders is less than 3 meq/kg, less than 2.5 meq/kg, less than 2.0 meq/kg, less than 1.5 meq/kg, or less than 1.0 meq/kg. In some embodiments, the peroxide value of ozone-treated peanuts is greater than 2.5 meq/kg, greater than 3.0 meq/kg, greater than 3.5 meq/kg, greater than 4.0 meq/kg, or greater than 5.0 meq/kg. Some embodiments include methods of reducing aflatoxin B1 in naturally-contaminated peanuts while simultaneously keeping a peroxide value within regulatory limits. In some embodiments, naturally-contaminated peanuts may be treated with a reducing agent to lower peroxide values.

Various embodiments of ozone-treated peanuts and methods of treating whole peanut kernels with ozone are described below in detail with reference to the figures included herein.

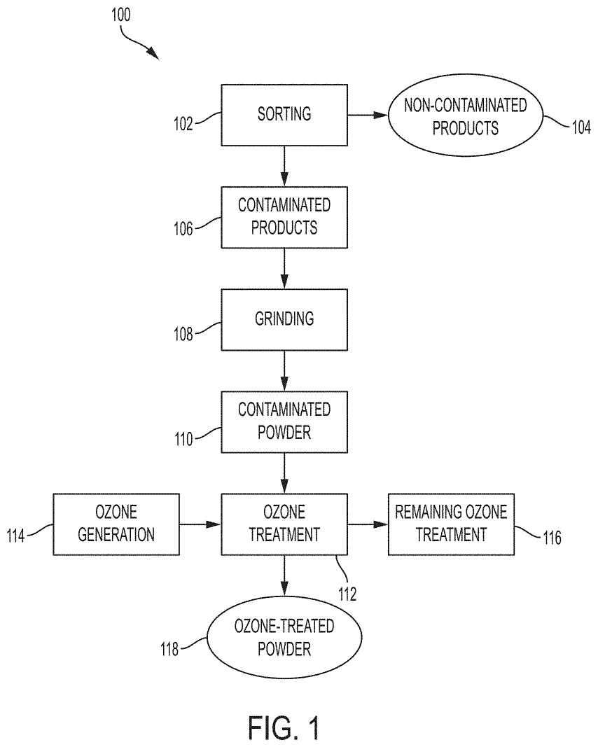

FIG. 1 provides a process diagram 100 of an ozone treatment process according to some embodiments described herein. In some embodiments, methods may comprise sorting 102. In some embodiments, sorting 102 may comprise physically sorting naturally-contaminated whole kernel peanuts from non-contaminated whole kernel peanuts. In some embodiments, sorting 102 may comprise optically sorting whole kernel peanuts according to color. In some embodiments, sorting 102 may comprise optically sorting whole kernel peanuts using ultraviolet radiation and/or Fourier-transform infrared spectroscopy. Color of whole peanut kernels may correlate with toxin, specifically aflatoxin, levels.

In some embodiments, sorting 102 may include optically sorting whole peanut kernels after cooking the whole peanut kernels and removing the red skin. In some embodiments, sorting 102 may include splitting the two halves of the whole peanut kernel and optically sorting the kernel halves. Sorting 102 may comprise any combination of whole peanut kernel, cooked peanut kernel, and/or halved peanut kernel sorting.

Non-contaminated food products 104 may be used for human consumption and/or animal consumption without treatment. For example, non-contaminated whole kernel peanuts may be used for human consumption and/or animal consumption without treatment. However, naturally-contaminated food products 106 may be treated to reduce aflatoxin levels such that they are suitable at least for animal consumption.

Naturally-contaminated food products 106 may comprise any combination food products resulting from the whole peanut kernel, cooked peanut kernel, and/or halved peanut kernel sorting methods. In some embodiments, naturally-contaminated food products 106 may be grinded in preparation for ozone treatment. Grinding 108 may increase the surface area-to-volume ratio of the food product to be treated, thus increasing the permeation of the ozone into the food product for the ozonolysis and oxidative reactions.

Grinding 108 may be completed using any commercially available blender, grinder, and/or mill on the market. In some embodiments, a Weiheng WH-A150 may be used. In some embodiments, a Weiheng WH-A150 may be used at 25000 rpm for 6-10 seconds to achieve an average peanut powder particle size suitable for ozone treatment. In some embodiments, a 5-15 size mesh may be used when grinding the whole peanut kernels to an average particle size. In some embodiments, a 10-20 size mesh maybe used. In some embodiments, a 15-25 size, 20-30 size, 25-35 size, 30-40 size, 35-45 size, or 40-50 size mesh may be used when grinding the peanut kernels to an average particle size. In some embodiments, a mesh size of less than 45, less than 40, less than 35, less than 30, less than 25, less than 20, less than 15, less than 10, or less than 5 may be used when grinding the particles to an average particle size. In some embodiments, a mesh size of greater than 2, greater than 4, greater than 5, greater than 10, greater than 15, greater than 20, greater than 25, greater than 30, greater than 35, or greater than 40 may be used when grinding the peanut kernels to an average particle size.

Grinding 108 may produce a naturally-contaminated food product powder. For example, grinding 108 may produce a naturally-contaminated peanut powder 110. This naturally-contaminated food product powder 110 may be subjected to ozone treatment 112 for aflatoxin reduction.

Ozone treatment 112 may be according to any of the embodiments disclosed herein. For example, ozone treatment 112 may include exposing naturally-contaminated peanut powder to aqueous ozone and/or mostly dry gaseous ozone. Ozone treatment 112 may comprise any of various ozone concentrations, treatment times, treatment temperatures, and/or other process variables discussed herein. Ozone treatment 112 may optionally include a holding period.

Ozone treatment 112 may expose naturally-contaminated peanut powder 110 to ozone generated according to ozone generation 114. For example, gaseous ozone may be generated by any commercially available ozone generator. For example, commercially available ozone generators include, but are not limited to, those by Anseros Advanced Ozone Technologies and Ozomax Inc. Gaseous ozone may be bubbled into water to produce an ozone-saturated aqueous solution.

After ozone treatment 112, any ozone remaining after the oxidative processes may undergo treatment 116. Ozone is highly reactive and may self-degrade into oxygen. In some embodiments, remaining ozone may be heated to 80 degrees Celsius and converted to oxygen.

Ozone treatment 112 results in ozone-treated peanut powder 118. Ozone-treated peanut powder 118 may be used in numerous applications, including but not limited to peanut cakes and peanut powder for animal feed.

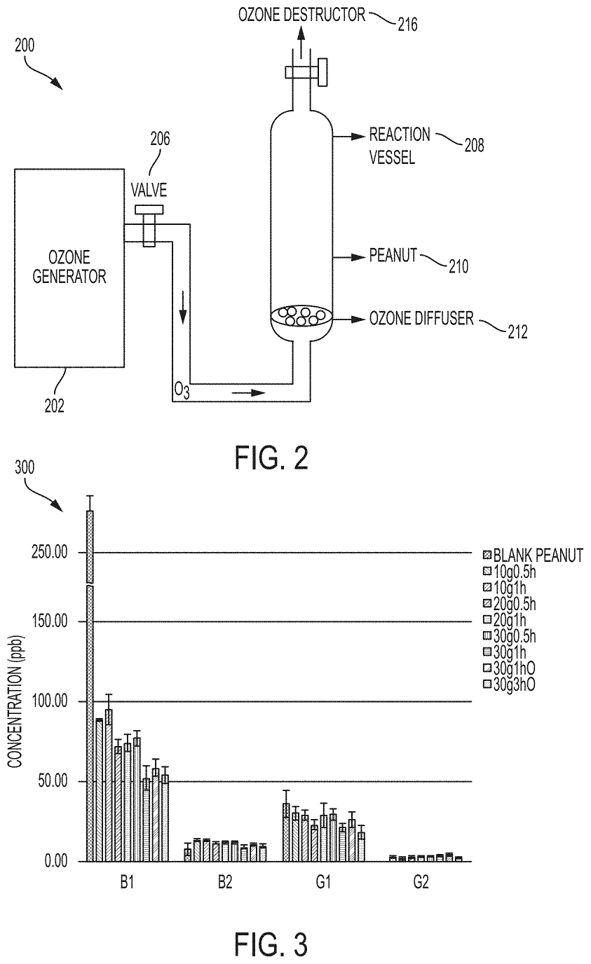

FIG. 2 shows ozonolysis process 200 according to some embodiments. Ozonolysis process 200 comprises an ozone generator 202 and a reaction vessel 208 for ozone treatment.

Ozone generator 202 forms ozone using any ozone generation methods known in the art. For example, gaseous ozone may be generating using a corona discharger apparatus. Corona discharger apparatuses may generate ozone by passing air or oxygen through two electrodes comprising a high potential difference due to an electric discharge process. The high potential difference between the two electrodes may cause the two atoms of molecular oxygen (O₂) to dissociate and react with other oxygen atoms to generate ozone (O₃). Gaseous ozone may also be generated using ionizing radiation. For example, UV radiation may cause the disassociation of oxygen molecules into free radical oxygen atoms, which may then react to form ozone.

Additionally, aqueous ozone may be generated using ozone generator 202 by bubbling gaseous ozone in water. When bubbled in water, ozone partially dissolves to create hydroxyl radicals that may oxidize contaminants in addition to molecular ozone.

In some embodiments, ozone output from ozone generator 202 may be controlled with valve 206. During ozone treatment, valve 206 may be opened to allow ozone to flow to reaction vessel 208. During a holding period or another period of non-flow, valve 206 may be closed to prevent ozone from flowing to reaction vessel 208.

Once generated by ozone generator 202, ozone may flow to reaction vessel 208 for treatment. Reaction vessel 208 may be any suitable reaction vessel. For example, many suitable reaction vessels, including but not limited to ozonation columns and/or fluidized beds, may be commercially available. In some embodiments, reaction vessel 208 may comprise ozone diffuser 212. Reaction vessel 208 may also hold food product to be treated with ozone.

In some embodiments, reaction vessel 208 may be a fluidized bed that may be configured to allow ozone to bubble up through a powder, to promote high levels of contact between the ozone gas and the peanut powder solid. A fluidized bed may enable the oxidation reactions to occur between the gaseous ozone and peanut powder particles. In some embodiments, a fluidized bed may include multiple holes at the bottom of the vessel where ozone may enter the fluidized bed from an ozone generator. Ozone may pass through the multiple holes in the bottom of the bed and flow up through the powder, creating the fluidization of the peanut powder. In some embodiments, the ozone may aerate the peanut powder in the fluidized bed to generate high surface area contact between the gaseous ozone and solid peanut powders per unit of bed volume.

In some embodiments, reaction vessel 208 is configured to hold peanuts 210 for ozone treatment. Peanuts 210 may be any form of peanut including, but not limited to, whole peanut kernels or peanut powder. In some embodiments, reaction vessel 208 may be configured to hold and treat other food products such as grain, corn, and/or nuts.

In some embodiments, ozone treatment may comprise applying a steady, continuous flow of a specified concentration of ozone to peanuts 210 in reaction vessel 208 for a specified treatment time. Within reaction vessel 208, natural air may also be present along with the treatment ozone.

After treatment, ozone that did not react with compounds in the peanuts may remain. However, because ozone can be very dangerous, particularly in high concentrations, any remaining ozone after ozone treatment should be destroyed. Accordingly, any remaining ozone may be destroyed with ozone destructor 216. In some embodiments, any remaining ozone may be treated with an exhaust system. For example, remaining ozone may exit reaction vessel 208 for destruction. In some embodiments, remaining ozone may be heated to 80 degrees Celsius and converted to oxygen. Ozone is highly reactive and readily self-decomposes into molecular oxygen. Further, ozone destructor 216 may be any known device commercially available. For example, Ozonetech® and OzoneLab™ provide commercial ozone destructors.

FIG. 3 provides a graph 300 of aflatoxin B1, B2, G1, and G2 content in ozone-treated peanuts according to various testing conditions. The testing variables include ozone concentration and exposure time. The X-axis represents the four different types of aflatoxins (B1, B2, G1, and G2), and the Y-axis represents the aflatoxin content level in parts per billion (ppb). The key for the graph provides the testing conditions for each data point, including ozone concentration and exposure time.

Ozone concentration may be between 5 g/m³ and 50 g/m³. In some embodiments, 5-15 g/m³ ozone may be used to treat peanuts. In some embodiments, 15-25 g/m³ ozone may be used to treat peanuts. In some embodiments, 25-35 g/m³ ozone may be used to treat peanuts. In some embodiments, 35-45 g/m³ ozone may be used to treat peanuts. In some embodiments, 10 g/m³, 20 g/m³ and/or 30 g/m³ may be used to treat peanuts.

Additionally, exposure time of the peanuts to ozone may vary. In some embodiments, exposure time may be between 0.25 hours and 5 hours. In some embodiments, exposure time may be 0.25-0.75 hours. In some embodiments, exposure time may be 0.75-1.25 hours. In some embodiments, exposure time may be 1.25-2 hours. In some embodiments, exposure time may be 2-4 hours. In some embodiments, exposure time may be between 2.5 and 3.5 hours. In some embodiments, exposure time may be 0.5 hours, 1 hour, and/or 3 hours.

FIG. 3 shows the effect of some ozone concentration and exposure time conditions on aflatoxin B1 level in naturally contaminated peanuts according to some embodiments. In FIG. 3, aflatoxin B1 content of untreated peanuts are provided, as well as peanuts treated at 10 g/m³ ozone for 0.5 hours, 10 g/m³ ozone for 1 hour, 20 g/m³ ozone for 0.5 hour, 20 g/m³ ozone for 1 hour, 30 g/m³ ozone for 1 hour, 30 g/m³ ozone for 3 hours, 30 g/m³ ozone for 1 hour with an overnight holding period, and 30 g/m³ ozone for 3 hours with an overnight holding period.

Interestingly, as shown in FIG. 3, the levels of both aflatoxin B1 and G1 decreased under all tested conditions, while the levels of both aflatoxin B2 and G2 increased under almost all tested conditions. These results are believed to be due to the C8-C9 double bond of the furan ring in aflatoxin B1 and G1, but not in aflatoxin B2 or G2. Accordingly, it appears that ozone readily oxidizes aflatoxin B1 and G1 at this C8-C9 double bond reaction site. However, because the toxicity of aflatoxin B1 is significantly greater than that of aflatoxin B2, G1, and/or G2, the overall toxicity (including that of aflatoxin B1, B2, G1, and G2 combined) of the peanut samples may decrease under all testing conditions.

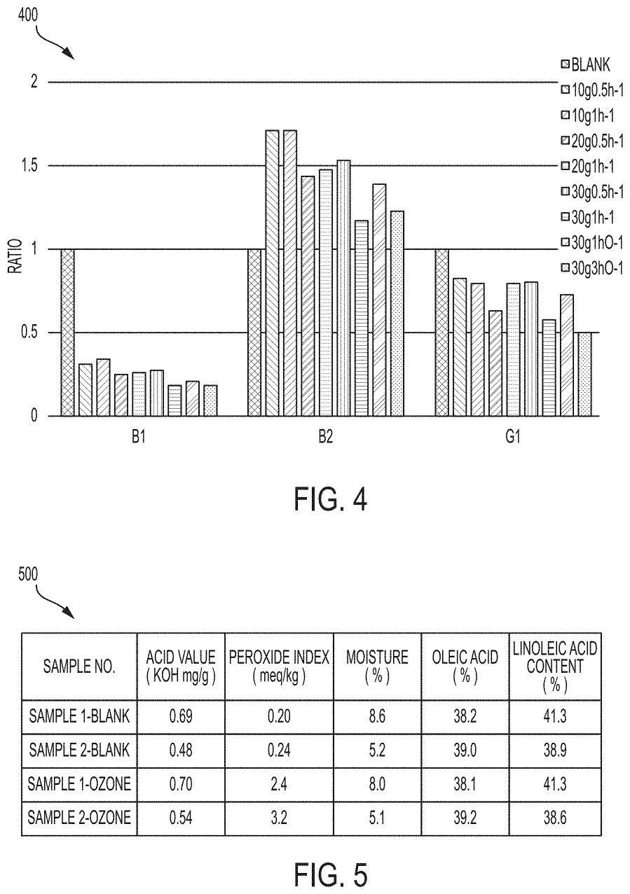

FIG. 4 provides a graph 400 of ratio of aflatoxin B1, B2, and G1 content before ozone treatment and after ozone treatment according to various testing conditions. The ratios are based on the aflatoxin levels reported in FIG. 4. The X-axis represents three of the four different types of aflatoxins (B1, B2, and G1), and the Y-axis represents the ratio of aflatoxin content before treatment to aflatoxin content after treatment. The key for the graph provides the testing conditions for each data point, including ozone concentration and exposure time.

The untreated peanuts of FIG. 4 are shown to the far left of each of the aflatoxin B1, B2, and G1 data points. Because these samples were not treated with ozone, the ratio of aflatoxin content before and after is one.

Notably, an increasing ozone concentration from 10 g/m³ to 20 g/m³ and 30 g/m³ does not seem to have a large impact on aflatoxin reduction. Additionally, no clear trends with an increase in exposure time were observed.

In some embodiments, analysis of the peanut quality before and after ozonolysis may consider the acid value, peroxide index, moisture, oleic acid content, and/or linoleic acid content.

In some embodiments, the acid value of peanut powders from pre-treatment to post-treatment may change less than 10%, less than 8%, less than 5%, less than 3%, less than 2%, less than 1%, less than 0.5%, or less than 0.1%. In some embodiments, the acid value of peanut powders from pre-treatment to post-treatment may change more than 0.1%, more than 0.5%, more than 1%, more than 3%, more than 5%, or more than 10%.

In some embodiments, the peroxide value of ozone-treated peanut powders is less than 3 meq/kg, less than 2.5 meq/kg, less than 2.0 meq/kg, less than 1.5 meq/kg, or less than 1.0 meq/kg. In some embodiments, the peroxide value of ozone-treated peanuts is greater than 2.5 meq/kg, greater than 3.0 meq/kg, greater than 3.5 meq/kg, greater than 4.0 meq/kg, or greater than 5.0 meq/kg.

In some embodiments, the moisture content of peanut powders from pre-treatment to post-treatment may remain relatively stable. In some embodiments, the moisture content may change by less than 10%, less than 8%, less than 5%, less than 3%, less than 1%, less than 0.5%, or less than 0.1%. In some embodiments, the moisture content may change by more than 0.1%, more than 0.5%, more than 1%, more than 3%, more than 5%, or more than 10%.

In some embodiments, the oleic acid content of peanut powders from pre-treatment to post-treatment may remain relatively stable. In some embodiments, the oleic acid content may change by less than 10%, less than 8%, less than 5%, less than 3%, less than 1%, less than 0.5%, or less than 0.1%. In some embodiments, the oleic acid content may change by more than 0.1%, more than 0.5%, more than 1%, more than 3%, more than 5%, or more than 10%.

In some embodiments, the linoleic acid content of peanut powders from pre-treatment to post-treatment may remain relatively stable. In some embodiments, the linoleic acid content may change by less than 10%, less than 8%, less than 5%, less than 3%, less than 1%, less than 0.5%, or less than 0.1%. In some embodiments, the linoleic acid content may change by more than 0.1%, more than 0.5%, more than 1%, more than 3%, more than 5%, or more than 10%.

### EXAMPLES

### Example 1

A sample of naturally-contaminated peanut powders of an average particle size of 20 mesh comprised an average aflatoxin B1 content of 253 ppb. The peanut powder sample was exposed to an ozone-rich environment of 30 mg/L for 3 hours at ambient temperature and pressure. Under these conditions, the average aflatoxin B1 content decreased to 65 ppb.

### Example 2

FIG. 5 provides testing results according to some embodiments of peanut powder composition comparing pre-treatment powder characterization to post-treatment characterization. Two samples of peanut powder were exposed to an ozone concentration of 30 g/m³ at 2 L/min for one hour. In some embodiments, the peanut powder was held in the column overnight for a holding period.

The results of Sample 1 show that the acid value of the peanut sample from pre-treatment to post-treatment may only increase by 0.01 KOH mg/g (0.69 KOH mg/g to 0.70 KOH mg/g). The peroxide index increased from 0.20 meq/kq to 2.4 meq/kg. The moisture content decreased slightly, from 8.6% to 8.0%. In some embodiments, the oleic acid content remained stable (38.2% to 38.1%), as did the linoleic acid content (41.3% to 41.3%).

The results of Sample 2 were similar. The acid value of the peanut powder sample from pre-treatment to post-treatment increased slightly, from 0.48 KOH mg/g to 0.54 KOH mg/g. Again, the peroxide index notably increased, from 0.24 meq/kg to 3.2 meq/kg. The moisture content remained stable, only decreasing slightly from 5.2% to 5.1%. The oleic acid content remained stable, from 39.0% to 39.2%, and the linoleic acid content remained stable as well, from 38.9% to 38.6%.

### Testing Methods

Analysis of peanut powders after treatment may be completed using various methods and instruments. For example, analysis may be completed using ELISA and/or ultra high-performance liquid chromatography tandem mass spectrometry (UPLC MS/MS).

Additionally, various commercially available methods and tools may be used to clean up and remove matrix effect before analyzing the aflatoxin levels in peanuts. In some embodiments, salt and lipid binding may be used. For example, Agilent's QuEChERS, which is commercially available, may be used for analyte extraction. In some embodiments, QuEChERS takes 30 minutes and is able to recover approximately 60% of the aflatoxin content. In some embodiments, solid phase extraction may be used, which is generally the fastest available method. For example, Romer Labs®'s MycoSep 226 may be used to extract the aflatoxin content of the peanut or peanut powder samples. In some embodiments, MycoSep 220 may take only 2 minutes, and recover approximately 60% of the aflatoxin content. In some embodiments, immunoaffinity may be used, which is generally a slower, yet more accurate method. For example, Romer Labs®'s AflaStar™ R and products by Vicam® are commercially available instruments that may be used. In some embodiments, Romer Labs®'s AflaStar™ R may take as much as 60 minutes, yet recover approximately 70% of the aflatoxin. In some embodiments, immunoaffinity columns by Vicam® may take 60 minutes, but recover 80% of the aflatoxin content.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

What is claimed as new and desired to be protected by Letters Patent of the United States is:

1. A method of reducing aflatoxin B1 content in peanuts comprising:
grinding peanuts containing a first amount of aflatoxin B1 to produce a peanut powder;
exposing the peanut powder to an ozone-rich environment to produce a peanut powder with a second amount of aflatoxin B1, wherein the second amount is less than the first amount.

2. The method of claim 1, wherein exposing the peanut powder to an ozone-rich environment comprises flowing an ozone-rich gas through the peanut powder at an ozone concentration of 10-30 g/m³.

3. The method of claim 1, wherein the peanut powder is exposed to the ozone-rich environment for 15 minutes or more.

4. The method of claim 3, wherein the peanut powder is exposed to the ozone-rich environment for 5 hours or less.

5. The method of claim 3, wherein the peanut powder is exposed to the ozone-rich environment for 3 hours or less.

6. The method of claim 1, wherein the peanut powder is exposed to the ozone-rich environment at ambient temperature and pressure.

7. The method of claim 1, further comprising holding the peanut powder in a sealed reaction vessel.

8. The method of claim 7, wherein the peanut powder is held in the sealed reaction vessel for 15 minutes or more.

9. The method of claim 8, wherein the peanut powder is held in the sealed reaction vessel for 12 hours or less.

10. The method of claim 1, wherein the peanuts are ground to an average particle size of less than 20 mesh.

11. The method of claim 1, further comprising presorting peanuts with an elevated amount aflatoxin B1 from peanuts with a lower amount of aflatoxin B1 and grinding and exposing to the ozone-rich environment only peanuts with the elevated amount of aflatoxin B1.

12. The method of claim 1, wherein the first percentage of aflatoxin B1 is greater than 200 ppb.

13. The method of claim 1, wherein the second percentage of aflatoxin B1 is less than 20 ppb.

14. The method of claim 1, wherein the ozone-rich environment is an aqueous ozone environment.

15. The method of claim 1, wherein the ozone-rich environment is ozone gas in air.

16. An ozone-treated peanut powder comprising:
less than 20 ppb aflatoxin B1; and
between 2.0 and 3.0 meq/kg peroxide.

17. The peanut powder of claim 16, wherein the peanut powder has an average particle size of less than 20 mesh.

18. The peanut powder of claim 16, wherein the peanut powder has less than 15 ppb aflatoxin B1.

19. The peanut powder of claim 16, wherein the peanut powder has greater than 2.5 meq/kg peroxide.

20. A treated peanut powder treated with an ozonolysis process comprising grinding peanuts to produce a peanut powder, and exposing the peanut powder to an ozone-rich environment, the treated peanut powder comprising:
less than 20 ppb aflatoxin B1; and
between 2.0 and 3.0 meq/kg peroxide.

21. The treated peanut powder of claim 20, wherein exposing the peanut powder to an ozone-rich environment comprises flowing an ozone-rich gas through the peanut powder at an ozone concentration of 10-30 g/m³.

22. The treated peanut powder of claim 20, wherein the treated peanut powder is exposed to the ozone-rich environment for 15 minutes or more.

23. The treated peanut powder of claim 22, wherein the treated peanut powder is exposed to the ozone-rich environment for 5 hours or less.

24. The treated peanut powder of claim 22, wherein the treated peanut powder is exposed to the ozone-rich environment for 3 hours or less.

25. The treated peanut powder of claim 20, wherein the treated peanut powder is exposed to the ozone-rich environment at ambient temperature and pressure.

26. The method of claim 20, wherein the ozonolysis process further comprises holding the peanut powder in a sealed reaction vessel.

27. The method of claim 26, wherein the peanut powder is held in the sealed reaction vessel for 15 minutes or more.

28. The method of claim 27, wherein the peanut powder is held in the sealed reaction vessel for 12 hours or less.

29. The treated peanut powder of claim 20, wherein the treated peanut powder has an average particle size of less than 20 mesh.

30. The treated peanut powder of claim 20, wherein the ozone-rich environment is an aqueous ozone environment.

31. The treated peanut powder of claim 20, wherein the ozone-rich environment is ozone gas in air.
